(19) United States
(12) Patent Application Publication
(10) Pub. No.: US 2008/0168174 A1
(43) Pub. Date: Jul. 10, 2008

(54) Computer on demand

(76) Inventors: Manuel Jose Acosta, Doral, FL (US); Boris Sacks, Miami Beach, FL (US)

Correspondence Address: MANUEL JOSE ACOSTA, SUITE 59, 10773 NW 58TH ST., DORAL, FL, 33178, US

(21) Appl. No.: 11/651,039

(22) Filed: Jan. 9, 2007

(51) Int. Cl. G06F 15/16

(52) U.S. Cl. 709/228

(57) ABSTRACT

The invention is a renting system to access computer hardware apparatus from any location to users without the need of purchasing and maintaining it. This connection can be achieved using standard telephone lines, local area network, Wireless connection, an Internet Service Provider or any other communication system that can get the connection in operational status.

### BACKGROUND OF INVENTION

1. Field of Invention

The present invention relates to the field of information services, more specifically to a procedure for accessing rented remote computers, that allows the users to login a session of an operating system so they can run any application from his rented computer as needed.

The availability of the service could be granted with a determined hourly service charge from a service provider, like for example the use of electric power, paid by kilowatt used over some period of time.

The provider can supply different extras to the customer's for example the ability to maintain the last software releases in their computers for the programs they use, upgrade to a new computer, etc. Depending on the operating system every computer will allow one or multiple sessions for login on to the user.

This service is provided using standard telephone lines, network, Internet Service Provider or any medium that allows the customer to run a process at their rented computer. The computers can be customized, for example the same computer can be using Unix Base Operating System (e.g., LINUX) or Windows terminal server (e.g., Cytrix) and be considered as just another computer rented but with some extra cost due to maintenance and bandwidth. This computer can give as many sessions to login as the configuration allows.

2. Discussion of Prior Art

A lot of people have personal computers in their homes and business. But they have to constantly upgrade software, make backups and sometimes after only a few months the computer they just bought is almost obsolete. Beyond of all this security is a serious issue and access to data and the control of the location of the data can be crucial for personal and business interests.

The access and technical services should give a 24×7 (all day, seven days a week) access to the computer, this should be under the consideration of the provider by the requirements of the clients. The provider is responsible for maintaining the latest updates in any software by agreement with the users and the software retailers, and the computer data and process are protected from any harm. Users can browse a web site and save the information in their remote computer even if they are using a cellular phone, because the user is not restricted by a local resource, its using a remote resource like the hard disk from your remote PC. This connection can be achieved using any communication protocol pre-arrange with the provider. Like X-protocol use for UNIX, terminal server use by Microsoft, etc.

You can rent a computer to be used in the corporate environment for your employees and avoid any security leaks because the service provider can monitor connections and applications. The transfer of data can be done using some proprietary protocol from the provider, public or private security protocols like SSH, etc.

The service provider can arrange a variety of facilities to improve the productivity of any company due to the security and cost consolidation. For example very expensive equipment like a plotter that can be purchased only by a few architectural companies, can be bought by the service provider to deliver a quality product for a group of users, that obviously couldn't afford it by themselves.

### OBJECTS AND ADVANTAGES

Several objects and advantages of the invention are:
(a) To provide the cost effective use of the latest software applications and computer hardware without the need of technical services or installations.
(b) To provide the backup service and the latest protection to the data without any interaction of the customer.
(c) To provide small users, corporations and Virtual Private Networks the security scrutiny of working hours, data transference, etc.
(d) To provide hotels, schools, corporations, local business, governments and in general the main public, use of up to date computers without the need of an Information Technologies department.
(e) To provide expensive hardware and software that couldn't be afforded by an individual or small business but that could be purchased by the provider as part of a service, and therein used by many customers.
(f) The provider could let the users install software to and from their remote computers to and from the provider location, complying with the necessary legal rights.

### SUMMARY

The invention is a renting computers system, which provides economical computer access from multiple locations using an existing communication infrastructure. The invention comprises a computer connected by any medium to any device that the customer allows to interact with the remote rented computers.

### DRAWING-FIGURES

FIG. 1 Illustrates a remote computer that allows multiple sessions to different devices that are connected using any possible connection to the remote computer. The connecting devices can be any electronic equipment able to display the computer session or able to start and manage a process in the session generated by the remote computer.

FIG. 2 Illustrates different individual remote computers that provides single sessions to different connecting devices. The connecting devices can be any electronic equipment able to display the computer session or able to start and manage a process in the session generated by the remote computer.

### LIST OF REFERENCES NUMERALS

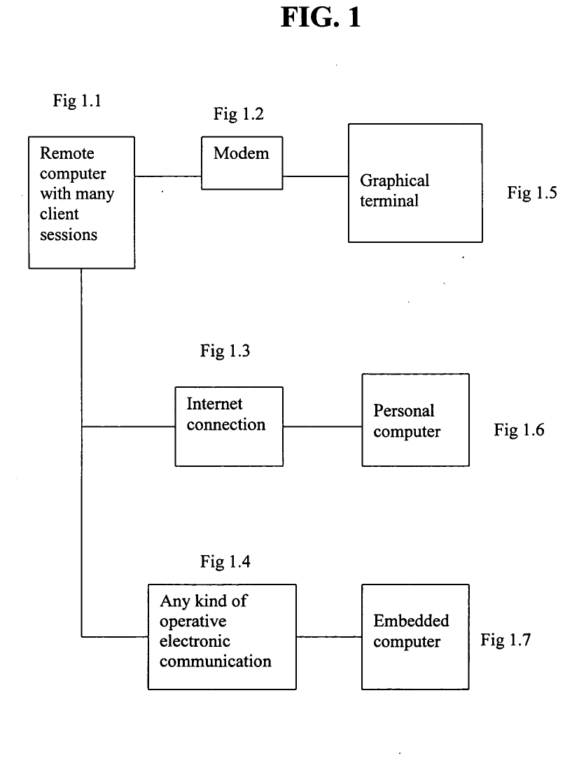

FIG. 1 Illustrates a remote computer that allows multiple sessions to different devices that are connected using any possible connection to the remote computer. The connecting devices can be any electronic equipment able to display the computer session or able to start and manage a process in the session generated by the remote computer.
FIG. 1.1 Remote computer with many client sessions
FIG. 1.2 Modem
FIG. 1.3 Internet connection
FIG. 1.4 Any kind of operative electronic communication
FIG. 1.5 Graphic terminal
FIG. 1.6 Personal computer
FIG. 1.7 Embedded computer (Like. Handheld device)

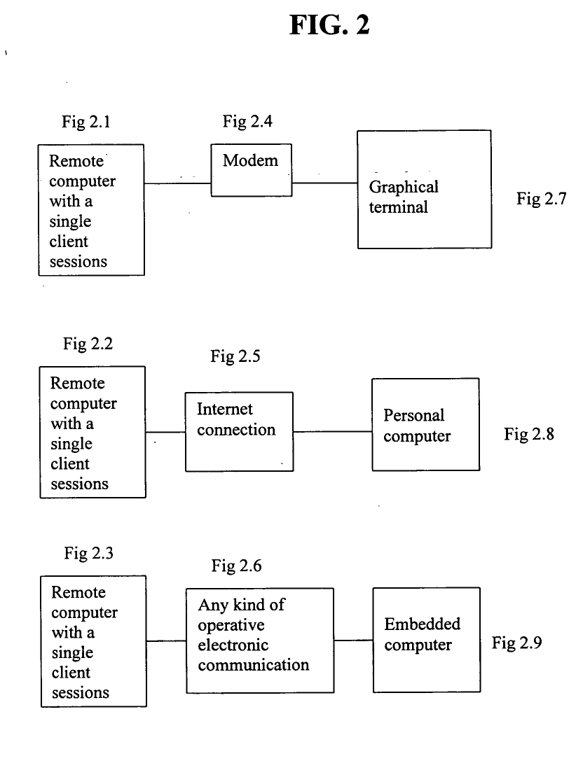

FIG. 2 Illustrates different individual remote computers that provides single sessions to different connecting devices. The connecting devices can be any electronic equipment able to display the computer session or able to start and manage a process in the session generated by the remote computer.
FIG. 2.1 Remote computer with a single client sessions
FIG. 2.2 Remote computer with a single client sessions
FIG. 2.3 Remote computer with a single client sessions
FIG. 2.4 Modem
FIG. 2.5 Internet connection
FIG. 2.6 Any kind of operative electronic communication
FIG. 2.7 Graphical terminal
FIG. 2.8 Personal computer
FIG. 2.9 Embedded computer (Like. Handheld device)

### DETAILED DESCRIPTION

The user can rent the use of any computer and be able to use it at any time for as long as he accepts the conditions subscribed by the supplier of the computer renting service. This computer can be of any range of options based on the supplier inventory. The provider can offer different choices for extras with different renting options. This service conditions between the user and the provider are defined by the provider.

### Operation of Invention

In operation the service allows the user to connect to their remote computer at any time. The rented computer can have a single session or multiple sessions depending of the operating system at use. The connection between the customer and the rented computer is done by any communication medium that allows the service.

### Description and Operation of Alternative Embodiments

Access for users to the rented remote computers eliminating the need to purchase and update personal computers, software and other services due to the virtual embodiment of the service providers package, the user can enjoy his applications without any worries about the specific hardware requirements necessary to operate them.

Companies can run without any Information Technologies department and have complete control over the projects and security of the systems with a 24×7 service. The service can ensure the business will work transparently even in the case the main office and employees of the company moves from Paris to Sydney.

### CONCLUSION RAMIFICATIONS AND SCOPE OF INVENTION

While my above description contains much specificity this should not constitute limitation on the scope of the invention, but rather be viewed as exemplification of one preferred embodiments thereof. Many other variations are possible. For example:

The computer to be rented can be any computer, with an operative connection the user.

The computer can have specialized software to run processes as complicated as needed. As an example, a collective remote rented computers can manage the process of a beer plant, this provides a high level of security in case that a problem happens in the plant the management of the system will be completely secure and can be remotely tuned.

Because the computers for corporations are located in the same providers facility the connection like emails, videoconferences or any data transfer are very fast and secure.

This provides a high level of security for governments, corporations, and schools. Emails and other insecure transfer of data can be traced easily giving a high security standard that had been lost due to lack of centralization of applications and resources.

The remote computer can use others computers locals or not to produce a result that can be presented to the user in a transparent way, like for example parallel processing of mathematical data.

The remote computer specifications can be customized to the connecting electronic device from the user making an optimum use of the electronic equipment configurations.

What is claimed is:

1. A remote renting computer service that gives sessions to users connecting using any communication protocol and by accepting the conditions subscribed by the supplier of the service, comprising:
a) a remote computer that the user rented that provides sessions.
b) any remote control computer device used by the user to connect and remotely control the rented computer.
c) a connection between said remote computer and said remote control computer device allowing data transfer between them.

2. A remote renting computer service that gives sessions to users connecting using any communication protocol and by accepting the conditions subscribed by the supplier of the service, comprising:
a) a remote computer that the user rented that provides sessions.
b) any electronic device used by the user to connect and remotely control the rented computer.
c) a connection between said remote computer and said electronic device allowing data transfer between them.

3. A remote computer using any network-base windows systems (e.g., x-protocol) providing access to any applications from the rented computer to the customer with electronic devices (e.g., personal computers) that are able to maintain an electronic connection to the remote computer.

4. The provider can use a virtualization software that consists of a virtual machine suit for any computer (for example Intel x86-compatible computers). This software will allows providers to set up multiple x86 virtual computers and to use one or more of these virtual machines simultaneously with the hosting operating system. Each virtual machine instance can execute its own guest operating system, such as (but not limited to) Windows, Linux, and BSD variants.
The use of these machines with the virtualization software for this service depends of the contract between the user and the provider.
